(19) United States
(12) Patent Application Publication
(10) Pub. No.: US 2005/0148711 A1
(43) Pub. Date: Jul. 7, 2005

(54) VOC free water reducible coating vehicles

(76) Inventor: Gerald Sugerman, Allendale, NJ (US)

Correspondence Address: EDWARDS & ANGELL, LLP, P.O. BOX 55874, BOSTON, MA, 02205, US

(21) Appl. No.: 10/850,627

(22) Filed: May 21, 2004

Related U.S. Application Data
(60) Provisional application No. 60/473,079, filed on May 23, 2003.

(51) Int. Cl. C08F 4/06

(52) U.S. Cl. 524/236; 524/556

(57) ABSTRACT

New and novel waterborne coating vehicles are disclosed. These vehicles are water reducible resins, produced via the reaction of the combination of hydroxyl bearing di/oligoamines (cf. Formula I), and carboxylic acid bearing resins derived from the (co)polymerization of vinyl, styrenic, and/or (meth)acrylate, monomers having carboxylic acid groups. Said vehicles are shown to be useful in the preparation of wear, water, and vibration resistant, volatile organic compound (“VOC”) free coatings, inks and paints.

### CROSS-REFERENCE TO RELATED APPLICATION

This application claims benefit of U.S. application Ser. No. 60/473,079, filed May 23, 2003, which is incorporated by reference in its entirety.

### BACKGROUND

Conventional polymeric vinyl, styrenic (meth)acrylate, and copolymer based water reducible coatings presently employ volatile ammonia or low molecular weight amines, as soubilizers, which materials generate significant proportions of volatilized organic compounds (VOCs) as pollutants, during their application.

It has now been surprisingly found that the replacement of the aforementioned VOCs by hydroxyl bearing di/oligoamines (cf. Formula I), r combinations thereof, as replacements for said volatile ammonia/amines, provides performance enhancement, in a variety of applications, as compared to known alternatives, in addition to the virtual elimination of VOCs.

Among said benefits is their unexpected utility as non-VOC generating replacements for conventional coalescents in latex based coatings.

It has further been determined that water reducible resins, produced via the reaction of the combination of hydroxyl bearing di/oligoamines (cf. Formula I), and carboxylic acid bearing resins, can function as effective ambient temperature curatives for epoxy resins, and/or as coalescing agents for a wide variety of latex resins. By contrast conventional water reducible resins prepared by the reaction with the same carboxylic acid group bearing resins with typically employed volatile amines (cf. Formula II) do not confer similar performance benefits.

These capabilities provide the formulator with a means to minimize pollution via the application of these versatile materials. Such advantages include, for example, the use of less noxious materials, and/or lessening of offensive or unacceptable conditions to the workers exposed to volatile, toxic, materials. In addition, as is demonstrated herein, said usage can provide the formulator with such product performance enhancements as faster drying inks and paints, coatings with improved wear and corrosion resistance, with reduced production costs, and increased ease of manufacture.

| Formula I | Formula II |
|---|---|
| H[RNHR¹]ₓ[R²N(R³)R⁴]_{y}[R⁵(OH)R⁶]_{z}H | N(ABC) |

wherein each R, R¹, R², R⁴ and R⁶ is independently a bond, divalent hydrocarbyl, or oxa hydrocarbyl ligands, each such ligand having from one to about six carbon atoms, inclusive of optional ether substituents (e.g., [—OCH₃ or —OC₃H₇]). Each R³, is independently hydrogen or monovalent one to six carbon saturated, or 2 to 6 carbon containing unsaturated hydrocarbyl or oxa hydrocarbyl ligand, and each R⁵, is independently chosen from among one to four carbon containing trifunctional ligands, wherein (x) and (y) are each independently an integer having a value of 0 to 6, except that the sum of x+y must equal or exceed 2, (z) is an integer having a value of 1, 2, or 3. In Formula II, A, B, and C are each independently hydrogen, one to about three carbon monovalent hydrocarbyl or monohydroxylated hydrocarbyl ligands. In preferred embodiments of this invention the terminal R is a bond and in the most preferred embodiments the terminal R is a bond and each R³ is hydrogen.

As used herein the term “hydrocarbyl” refers to a radical containing hydrogen and carbon only, the term “oxa hydrocarbyl” refers to a radical containing an ether function, that is, —O— oxygen, carbon and hydrogen only, the term “unsaturated” refers to the presence of “C═C bonding” or “carbon-carbon double bonds) in the ligand, the term “trifunctional ligand” refers to a ligand having three bonding sites [e.g., —CH(—)CH₂—, 1,3,5-C₆H₃, —OCH₂C(—)═CH(—)]. The term “multifunctional” refers to a ligand containing multiple functional groups, (e.g., an amino group and a hydroxyl group in the same ligand). The term “essentially nonvolatile” refers to the characteristic that the substance at issue is of extremely low volatility, or alternatively essentially meets or exceeds one or more of the following volatility criteria, and as such, is considered of a nonvolatile nature: 1) United States Environmental Protection Agency (EPA) Method 24; 2) American Society for Testing Materials (ASTM) Method D3960; 3) has a vapor pressure ≦0.1 mm Hg at use temperature. The term “organic carboxylic acid group functional equivalent” refers to a chemical group that functionally acts as a carboxylic acid group. For example, a carboxylic acid ester or anhydride, or other such carboxylic acid derivative, is suitable for use in the compositions described herein. Particularly suitable are those that under certain aqueous conditions are prone to hydrolysis such that a corresponding free carboxylic acid functional group results.

### SUMMARY OF THE INVENTION

The invention relates to new and novel waterborne coating vehicles, methods of making them, and methods of using them.

One aspect is a composition of matter comprising (consisting essentially of) one or more polymeric organic carboxylic acid group containing resin(s) and one or more multifunctional hydroxyl bearing di/oligoamines, as defined in formula A.
H[RNHR¹]ₓ[R²N(R³)R⁴]_{y}[R⁵(OH)R⁶]_{z}H Formula A

wherein each R, R¹, R², R⁴ and R⁶ is independently a bond, divalent hydrocarbyl, or oxa hydrocarbyl ligands, each such ligand having from one to about six carbon atoms, inclusive of optional ether substituents (e.g., [—OCH₃ or —OC₃H₇]. Each R³, is independently hydrogen or monovalent one to six carbon saturated, or 2 to 6 carbon containing unsaturated hydrocarbyl or oxa hydrocarbyl ligand, and each R⁵, is independently chosen from among one to four carbon containing trifunctional ligands, wherein (x) and (y) are each independently an integer having a value of 0 to 6, except that the sum of x+y must equal or exceed 2, (z) is an integer having a value of 1, 2, or 3.

In one embodiment, the invention is a composition of matter comprising (consisting essentially of) one or more polymeric organic carboxylic acid group containing resin(s) and one or more multifunctional hydroxyl bearing di/oligoamines.

In an alternate embodiment, the composition is any of those delineated herein wherein the multifunctional hydroxyl bearing di/oligoamine(s) are essentially nonvolatile, and alternatively any of those delineated herein wherein the multifunctional hydroxyl bearing di/oligoamine(s) comprise at least one primary, or alternatively at least two, or alternatively at least three, amino ligand(s). In an alternate embodiment, the composition is any of those delineated herein wherein the multifunctional hydroxyl bearing di/oligoamine(s) comprise at least one primary (e.g., NH₂), or alternatively at least two, or alternatively at least three, secondary amino ligand(s) (e.g., NHR, NHR², wherein R or R² are as defined herein) and at least one hydroxyl group.

In an alternate embodiment, the composition is any of those delineated herein wherein the polymeric organic carboxylic acid group containing resin(s) further comprises non-carboxylic acid based monomers. In an alternate embodiment, the composition is any of those delineated herein wherein the polymeric organic carboxylic acid group containing resin(s) comprises at least one, or alternatively at least two, free carboxylic acid groups.

In an alternate embodiment, the composition is any of those delineated herein wherein one or more of the organic carboxylic acid groups is replaced with one or more polymeric organic carboxylic acid group functional equivalents, such as acid halides and/or anhydrides.

In an alternate embodiment, the composition is any of those delineated herein wherein the one or more polymeric organic carboxylic acid group containing resin(s), further comprises non-carboxylic acid based monomers. Representative examples of such monomers, include but are not limited to, for example, (meth)acrylic esters, styrene, vinyl chloride, vinyl ethers, or vinyl esters.

In an alternate embodiment, the composition is any of those delineated herein comprising any combination of polymeric organic carboxylic acid group containing resin(s) and multifunctional hydroxyl bearing di/oligoamine(s) expressly delineated herein.

In an alternate embodiment, the composition is any of those delineated herein comprising any combination of polymeric organic carboxylic acid group functional equivalent containing resin(s) and multifunctional hydroxyl bearing di/oligoamine(s) expressly delineated herein.

In an alternate embodiment, the composition is any of those delineated herein comprising the combination and formulation of polymeric organic carboxylic acid group functional equivalent containing resin(s) and multifunctional hydroxyl bearing di/oligoamine(s) expressly delineated herein.

In an alternate embodiment, the composition is any of those delineated herein further comprising an additional solvent, alternatively wherein the additional solvent is water, or alternatively wherein the additional solvent is an organic solvent (e.g., organic ether, ester, ketone, or alcohol). Such additional solvent may be introduced at any time appropriate for the application. For example, the solvent may be introduced prior to final packaging of the composition or introduced immediately prior to use of the composition.

In alternate embodiments, what is envisioned is the use of any of the compositions delineated herein as an epoxy curative, a vehicle for a coating, a vehicle for a paint, or a printing ink. The uses include applying the compositions delineated herein to a substrate. Substrates are any solid material suitable for the application (e.g., painting, printing, coating, adhering). For example, paper, cardboard, fabric, cloth, plastic, fiberglass, laminates, wood, metals (e.g., aluminum, steel, brass, iron, copper, titanium, etc.), stone, cement, marble, ceramic, vinyl, glass, polymers, and the like are suitable as substrates. The applying of the compositions herein can be accomplished by any suitable method, including for example, by brush, mop, sprayer, either manually or using an automated applicator or machine, e.g. inkjet, flexographic, gravure, silk screen, or lithographic printer.

Further embodiments include a method of producing an epoxy curative, a coating, a paint, or a printing ink, comprising combining the components of any of the compositions delineated herein; a method of producing an epoxy curative comprising combining the components of the compositions [derived from the interaction of an hydroxy bearing di(oligo) amine with a carboxyl bearing resin] delineated herein and one or more additional epoxy curative additive or additives; a method of producing a coating comprising combining the components of the composition delineated herein and one or more additional coating additive or additives; a method of producing a paint comprising combining the components of the composition delineated herein and one or more additional paint additive or additives; a method of producing a print ink comprising combining the components of the composition delineated herein and one or more additional print ink additive or additives.

Additives for epoxy curative compositions are known in the art. They include, for example, surfactants, catalysts, retarders, solvents, and the like. Additives for coating, paint, or print ink compositions are known in the art. They include, for example, rheology control agents, antifoaming agents, biostatic agents, and the like.

Further embodiments include a method of making a composition delineated herein comprising combining one or more polymeric organic carboxylic acid group containing resin(s) and one or more multifunctional hydroxyl bearing di/oligoamines; and a method of making a composition delineated herein comprising combining one or more polymeric organic carboxylic acid group containing resin(s) delineated herein and one or more multifunctional hydroxyl bearing di/oligoamines delineated herein.

Further embodiments include a product made by the process of any of methods delineated herein.

Further embodiments include a method of printing on a substrate comprising applying a product or composition delineated herein or prepared by a method delineated herein to the substrate; a method of painting a substrate comprising applying a product delineated herein or prepared by a method delineated herein to the substrate; a method of coating a substrate comprising applying a product delineated herein or prepared by a method delineated herein to the substrate; a method of curing an epoxy on a substrate comprising applying a product delineated herein or prepared by a method delineated herein to the substrate; a method of adhering a first substrate to a second substrate comprising applying a product delineated herein or prepared by a method delineated herein to the first substrate and contacting the first substrate to the second substrate, which method can further comprise applying a product delineated herein or prepared by a method delineated herein to the second substrate; and a method of protecting a substrate surface comprising applying a product delineated herein or prepared by a method delineated herein to the substrate surface.

In an alternate embodiment, the composition of matter comprises a volatile organic compound (“VOC”) free waterborne vehicle comprising any of the compositions delineated herein. In an alternate embodiment, the composition of matter herein is essentially volatile organic compound (“VOC”) free. The term “VOC free” refers to substances essentially not made from, or not comprising, chemical components that are considered volatile organic compounds as that term is known in the art.

The varieties of hydroxyl bearing di/oligoamines which have been found to be useful in the practice of this invention are legion, a few examples are given in Table A, and preferred examples of preferred embodiments are indicated with a *. Said examples are intended to be illustrative of, but neither exhaustive of, nor to delimit the scope of this invention.

TABLE A

| | |
|---|---|
| A1)* | 1,3-bis amino-2-propanol |
| A2)* | 1-amino-2-N(methyl)amino-3-propanol |
| A3)* | N(2-hydroxyethyl)ethylene diamine |
| A4)* | 2,4-bis amino-1-cyclohexanol |
| A5)* | 2-methyl-3-aza-6-amino-1-octanol |
| A6)* | 1,7-bis amino-4-oxa-2-heptanol |
| A7) * | 2,5,8,11,14-penta amino-3,6,9,12-tetra |
| | oxa-1,15-pentadecanediol |
| A8) * | 4-N(3-aminopropyl)-2-buten-1-ol amine |
| A9) * | 2-amino-3-[(2-hydroxy)-2-propyl]morpholine |
| A10)* | 2,4-bis N-butlyamino-3,5-bis hydroxy n-pentyl amine |
| A11)* | 2-(2-propenoxy),2-bis aminomethyl, ethanol |
| A12)* | 1-N-(ethyl)amino,2-amino,-3,4,5,-tris hydroxy hexane |
| A13)* | 2-N-(vinyl)3-hydroxy-1,2-propylenediamine |
| A14)* | 2-hydroxy-5-cyano-1,5-pentane diamine |
| A15)* | 4,4′ bis amino-2-hydroxy methyl bis cyclohexyl ether |
| A16)* | N-(2-hydroxy)propyl triethylene tetramine |
| A17)* | 1,3 bis amino-5-(3-hydroxy)butyl cyclopentadiene |
| A18)* | 3-amino-1,6-bis N(ethyl)amino-2-pentanol |
| A19)* | bis 2-aminomethyl-2-hydroxypropyl ether |
| A20)* | 4-hydroxyethyl tetraethylene pentamine |
| A21)* | N-(hydroxymethyl)ethylene diamine |
| A22)* | N¹(2-propionyl)N³(2-hydroxyethyl)diethylene triamine |
| A23) | 1,3-bis methylamino-2-propanol |
| A24) | 1-N(butyl)amino-2-N(methyl)amino-3-propanol |
| A25) | N,N′ bis(2-hydroxyethyl)ethylene diamine |
| A26) | 2,4-bis N,N′ bis isopropylamino cyclohexanol |
| A27) | 2-methyl-3-aza-6-(N methyl)amino octanol |
| A28) | 1,7-bis N(butyl)amino-4-oxa-2-heptanol |
| A29) | 2,5,8,11,14-penta(N-Methyl)amino-3,6,9,12-tetra |
| | oxa-1,15-pentadecanediol |
| A30) | 4,N(3-aminopropyl)-2-butenol-1 |
| A31) | 2-amino-3-[(2-hydroxy)-2-propyl]morpholine |
| A320) | 2-hydroxy-5-cyano-1,5-pentane bis(N-ethyl)amine |
| A33) | 4,4′ bis amino-2-hydroxy methyl bis cyclohexyl ether |
| A34) | N,N′ bis(hydroxymethyl)ethylene diamine |

The varieties of carboxylic acid group bearing polymers, and of latex resins, which have been found to be useful in the practice of this invention, are legion, a few examples of the preferred varieties are given in Table B, and B* respectively. Said examples are intended to be illustrative of, but neither exhaustive of, nor to delimit the scope of this invention.

TABLE B

| Resin | | | |
|---|---|---|---|
| (K) | Component monomers | Mole ratios | Mn//Mw |
| B1) | Phthalic anhydride/diethylene glycol | 1:0.98 | 2.4//15 |
| B2) | Maleic acid/1,4-butene diol/citric acid | 1:1.7:0.72 | 1.1//21 |
| B3 | Adipic acid/propylene glycol/fumaric acid¹ | 1;1;0.05 | 0.8//2.7 |
| B4) | Polyethylene glycol 4K/trimeletic anhydride | 1:0.68 | 4.5//8.6 |
| B5) | Acrylic acid/styrene | 1:2 | 3.1//23 |
| B6) | Methacrylic acid/methyl methacrylate/butyl methacrylate | 1:2:4 | 2.7//12 |
| B7) | Maleic acid/ethylene/ethyl acrylate | 1:2.2:2 | 1.9//13 |
| B8) | Acrylic acid/methacrylic acid/2-butene/propylene | 1:1:1:1 | 3.8//20 |
| B9) | Styrene/acrylonitrile/acrylic acid | 1:1:0.1 | 2.2//11.4 |
| B10) | Styrene/methacrylic acid/styrene (block copolymer) | 1:1:1 | 2.8//9.4 |
| B11) | Alkyd resins (short and medium oil) | | |

Examples of volatile amines which are widely used conventionally to solubilize water reducible carboxylic acid bearing resins, and of non volatile amines which are not suitable for use in the practice of this invention, are provided in Tables C and D, respectively.

TABLE C

| | |
|---|---|
| CA) | Ammonia |
| CB) | Triethylamine |
| CC) | Ethanolamine |
| CD) | 2-(amino)methyl-2-propanol |
| CE) | Triethylene diamine |

TABLE D

| | |
|---|---|
| D1) | N(bis methyl), N′(methyl), (2-hydroxy ethyl)ethylene diamine |
| D2) | 2-amino,4-N,N bis(ethyl)amino cyclohexanol |
| D3) | 2-N,N′ bis(methyl)amino-3-[(2-hydroxy)-2-propyl]morpholine |
| D4) | Tetraethylene pentamine |
| D5) | N¹,N²-bis ethanoyl, N³(2-hydroxyethyl)diethylene triamine |

Methods suitable for the preparation, and applications, of the new and novel waterborne vehicles of the instant invention, are legion, and comprise well-established art. Applications of these vehicles include superior printing ink, and paint and coatings formulations, exemplified by Examples 1, and 2 through 8, respectively. Said examples are intended to be illustrative of, but neither exhaustive of, nor to delimit the scope of this invention.

### EXAMPLES

### Example 1

Preparation of the VOC free Resin vehicles of the instant invention was generally readily achieved by high shear admixture of the appropriate carboxylic acid containing polymer and about 40 to 200%, of the equivalent weight (basic nitrogen per acid group) of the appropriate counterion forming amine, in water, or waterborne resin systems. Temperatures employed to effect the resin dispersions were in the range of from 60° C. to ˜80° C. Vehicles thus prepared had solids concentrations, which ranged from 10 to about 65 weight percent. Contrary to the results produced with the analogous conventional types of systems which when prepared in open, and/or flowing nitrogen blanketed reactors (control specimens), the loss of base, and consequent odor generation, during resin solubilization-dispersion was minimal, even at process temperatures as high as 98° C. Details concerning the composition, stability, and dried film water resistance, of a variety of VOC free resin vehicles of this invention, and counter examples of conventional art analogs are give in Tables #1. The effect of the addition of 0.2 wt. % of the indicated amidation catalyst(s), on the performance of selected formulations, is provided in Table # 1*.

TABLE #1

| | CO2H//Amine | Product max. | Dried film scrub |
|---|---|---|---|
| Product | ratio//eqiv. | conc. wt. %¹ | resistance² |
| 1A) | B1//CA//0.5 | 12 | <50 |
| 1B) | B1//CA//1.0 | 26 | ˜80 |
| 1C) | B1//CA//1.5 | 29 | <80 |
| 2A) | B1//CB//0.5 | 10 | <50 |
| 2B) | B1//CB//1.0 | 20 | <80 |
| 2C) | B1//CB//1.5 | 22 | ˜80 |
| 3A) | B1//D4//0.5 | 12 | <50 |
| 3B) | B1//D4//1.0 | 26 | <50 |
| 3C) | B1//D4//1.5 | 29 | <50 |
| 4A) | B1//D5//0.5 | 10 | <50 |
| 4B) | B1//D5//1.0 | 20 | <50 |
| 4C) | B1//D5//1.5 | 22 | <50 |
| 5A) | B1//A5//0.5 | 22 | 140 |
| 5B) | B1//A5//1.0 | 27 | 190 |
| 5C) | B1//A5//1.5 | 29 | 150 |
| 6A) | B1//A8//0.5 | 31 | 180 |
| 6B) | B1//A8//1.0 | 30 | 210 |
| 6C) | B1//A8//1.5 | 32 | 160 |
| 7A) | B1//A12//0.5 | 42 | 110 |
| 7B) | B1//A12//1.0 | 46 | 190 |
| 7C) | B1//A12//1.5 | 39 | 180 |
| 8A) | B1//A19//0.5 | 10 | 90 |
| 8B) | B1//A19//1.0 | 20 | 120 |
| 8C) | B1//A19//1.5 | 22 | 100 |
| 9A) | B1//A27//0.5 | 14 | 70 |
| 9B) | B1//A27//1.0 | 22 | 110 |
| 9C) | B1//A27//1.5 | 22 | 90 |
| 10A) | B1//A30//0.5 | 19 | 140 |
| 10B) | B1//A30//1.0 | 24 | 190 |
| 10C) | B1//A30//1.5 | 27 | 150 |
| 11A) | B10//CA//0.5 | 11 | ˜80 |
| 11B) | B10//CA//1.0 | 20 | 110 |
| 11C) | B10//CA//1.5 | 22 | 110 |
| 12A) | B10//D3//0.5 | 8 | 70 |
| 12B) | B10//D3//1.0 | 16 | 90 |
| 12C) | B10//D3//1.5 | 19 | 80 |
| 13A) | B10//A9//0.5 | 10 | 190 |
| 13B) | B10//A9//1.0 | 20 | 220 |
| 13C) | B10//A9//1.5 | 22 | 200 |
| 14A) | B10//A13//0.5 | 31 | 280 |
| 14B) | B10//A13//1.0 | 30 | 290 |
| 14C) | B10//A13//1.5 | 32 | 260 |
| 15A) | B10//A29//0.5 | 22 | 140 |
| 15B) | B10//A29//1.0 | 26 | 190 |
| 15C) | B10//A29//1.5 | 24 | 180 |

TABLE 1*

| | CO2H//Amine | Product max. | | Dried film scrub |
|---|---|---|---|---|
| Product | ratio//eqiv. | conc. wt. %¹ | Catalyst | resistance² |
| 1B) | B1//CA//1.0 | 20 | none | 80 |
| | ″ | 20 | MeSO₃H | 90 |
| | ″ | 20 | SbOCl₃ | 80 |
| | ″ | 20 | TiAA³ | 90 |
| 2B) | B1//CB//1.0 | 20 | none | 80 |
| | ″ | 20 | MeSO₃H | 80 |
| | ″ | 20 | SbOCl₃ | 80 |
| | ″ | 20 | TiAA | 90 |
| 3B) | B1//D4//1.0 | 20 | none | <50 |
| | ″ | 20 | MeSO₃H | 80 |
| | ″ | 20 | SbOCl₃ | 80 |
| | ″ | 20 | TiAA | 90 |
| 4B) | B1//D5//1.0 | 20 | none | <50 |
| | ″ | 20 | MeSO₃H | 60 |
| | ″ | 20 | SbOCl₃ | 50 |
| | ″ | 20 | TiAA | 80 |
| 5B) | B1//A5//1.0 | 20 | none | 190 |
| | ″ | 20 | MeSO₃H | 260 |
| | ″ | 20 | SbOCl₃ | 250 |
| | ″ | 20 | TiAA | 380 |
| 6B) | B1//A8//1.0 | 20 | none | 200 |
| | ″ | 20 | MeSO₃H | 250 |
| | ″ | 20 | SbOCl₃ | 250 |
| | ″ | 20 | TiAA | 320 |
| 7A) | B1//A19//0.5 | 20 | none | 90 |
| | ″ | 20 | MeSO₃H | 180 |
| | ″ | 20 | SbOCl₃ | 190 |
| | ″ | 20 | TiAA | 250 |
| 8B) | B1//A27//0.5 | 20 | none | 110 |
| | ″ | 20 | MeSO₃H | 140 |
| | ″ | 20 | SbOCl₃ | 150 |
| | ″ | 20 | TiAA | 150 |
| 9A) | B1//A30//0.5 | 19 | none | 140 |
| | ″ | 19 | MeSO₃H | 140 |
| | ″ | 19 | SbOCl₃ | 150 |
| | ″ | 19 | TiAA | 150 |
| 10A) | B10//CA//0.5 | 11 | none | 80 |
| | ″ | 11 | TiAA | 90 |
| 11A) | B10//CA//0.5 | 11 | MeSO₃H | 90 |
| 11C) | B10//CA//1.5 | 11 | none | 110 |
| 12B) | B10//D3//1.0 | 16 | none | 90 |
| | ″ | 16 | MeSO₃H | 100 |
| | ″ | 16 | SbOCl₃ | 120 |
| | ″ | 16 | TiAA | 110 |
| 13C) | B10//A9//1.5 | 22 | none | 200 |
| | ″ | 22 | MeSO₃H | 230 |
| | ″ | 22 | Sb₂O₃ | 230 |
| | ″ | 22 | Ti DOPP | 250 |
| 14A) | B10//A19//0.5 | 10 | none | 90 |
| | ″ | 10 | MeSO₃H | 130 |
| | ″ | 10 | Sb₂O₃ | 130 |
| | ″ | 10 | Ti DOPP | 150 |
| 15B) | B10//A27//1.0 | 20 | none | 110 |
| | ″ | 20 | Sb₂O₃ | 120 |
| | ″ | 20 | TiAA | 140 |
| 16B) | B4//A30//1.0 | 20 | none | 190 |
| | ″ | 20 | MeSO₃H | 210 |
| 17B) | B6//A29//0.40 | 20 | none | 140 |
| | ″ | 20 | MeSO₃H | 130 |
| | ″ | 20 | Sb₂O₃ | 130 |
| | | 20 | Ti DOPP | 150 |
| 18A) | B10//A30//0.5 | 10 | none | 180 |
| | ″ | 10 | MeSO₃H | 230 |
| | ″ | 10 | Sb₂O₃ | 220 |
| | ″ | 10 | Ti DOPP | 210 |

Notes:
¹Total solids by U.S. Environmental Protection Agency (“EPA”) Federal method # 24 Section 51. equivalent to American Society for Testing and Materials (“ASTM”) #D-3960.
²Test coating was applied by doctor blade to polyethylene terphthalate film, at 2.5 mm (calculated) dry film coating thickness, air dried @ 25° C. for 1 hour, then evaluated by a vehicle (only) modified version of ASTM method #D 4213.
³Titanium bis acetylacetonate.
4) Titanium bis(bis octyl)bis phosphate.

### Example 2

This example demonstrates the superior utility of the VOC free vehicles of the instant invention as waterborne flexographic ink vehicle components.

A uniform aqueous dispersion containing 30 weight percent solids, was prepared by high-speed disperser mixing of the appropriate quantity of a styrene acrylic copolymer (B5), acid equivalent wt. 155, with the specified proportionate equivalents of the indicated amines. The resulting materials were each evaluated for utility as a vehicle component (50 percent by weight), 25 weight percent rutile titanium dioxide powder, and ˜23+/−2% of water, in conjunction with suitable proportions, alternatively about 0.1% to about 1%, each of antifoam, biostat, or polyurethane thixotrope as required to attain a finished ink viscosity of or between 3.0-3.1 K cps. to produce a white ink.

The resulting inks were printed on a 60 Shore D durometer, 1 m wide 2.5 mm thick vinyl web via the use of a commercial press (65° C. drying) @ 60% coverage, using conventional waterborne flexographic printing techniques. Amine/equivalent, maximum sustainable print rate, blocking and print resistance to various corrosives are documented in Table 2. These data demonstrate the superiority of the instant invention vs. existing materials in the art, with respect to minimizing VOC generation, sustainable print speed and corrosion resistance.

TABLE 2

| Amine// | | Performance M//M/2 ³ | | | |
|---|---|---|---|---|---|
| Meq. %//B5 | Max IPH¹(K⁾ | Blocking, | water, | soy oil, | vinegar |
| CA//50 | 5.7 | 48//55 | G//G | P//F | P//P |
| CA//100// | 14.4 | 61//63 | G//G | F//F | P//P |
| CA//150// | 14.1 | 61//64 | G//G | F//F | P//P |
| CA//200// | 12.7 | 59//62 | F//G | F//G | P//P |
| CD//50// | 6.9 | 34//49 | F//G | F//F | P//P |
| CD//100// | 13.8 | 52//59 | F//G | F//F | P//P |
| CD//150// | 11.3 | 47//54 | F//F | F//F | P//P |
| CE//50// | 4.6 | 42//50 | F//F | F//G | P//F |
| CE//100// | 10.7 | 56//60 | F//G | G//G | P//F |
| CE//150// | 8.8 | 55//59 | F//F | G//G | P//P |
| D1//50// | 2.9 | <30//33 | F//G | F//F | F//F |
| D1//100// | 4.3 | <30//35 | P//F | F//F | P//F |
| D2//50// | 3.7 | 32//38 | F//F | F//F | P//F |
| D2//100// | 9.8 | 39//42 | F//F | F//F | F//F |
| D2//150// | 8.7 | 31//41 | P//F | F//F | P//F |
| D3//50// | 3.1 | <30//39 | P//F | P//F | P//F |
| D3//100// | 7.9 | 34//40 | P//F | F//F | P//F |
| D4//50// | 4.0 | 31//43 | P//P | F//F | P//P |
| D4//100// | 9.1 | 35//45 | P//P | F//F | P//P |
| D5//50// | 3.2 | 31//37 | P//P | F//F | P//F |
| D5//100// | 8.7 | 37//40 | P//P | F//F | P//F |
| A1//50// | 20+⁴ | 62//69 | G//G | F//G | F//G |
| A1//100// | 20+⁴ | 78//79 | E//E | G//G | E//E |
| A1//150// | 20+⁴ | 76//79 | E//E | G//E | G//G |
| A1//200// | 20+⁴ | 72//79 | F//E | G//E | F//G |
| A6//50// | 20+⁴ | 70//74 | G//G | G//G | F//G |
| A6//0.5// | 20+⁴ | 70//75 | G//E | G//E | G//G |
| A6//100// | 20+⁴ | 76//79 | E//E | E//E | E//E |
| A6//150// | 20+⁴ | 76//79 | E//E | G//E | G//G |
| A6//200// | 20+⁴ | 72//77 | G//E | G//E | F//G |
| A12//50// | 20+⁴ | 69//69 | G//G | F//G | F//G |
| A12//100// | 20+⁴ | 70//72 | E//E | G//G | E//E |
| A12//150// | 20+⁴ | 70//71 | E//E | G//E | G//G |
| A12//200// | 20+⁴ | 69//70 | G//E | G//E | G//G |
| A18//50// | 20+⁴ | 80//79 | G//E | G//G | F//G |
| A18//100// | 20+⁴ | 78//79 | E//E | G//G | E//E |
| A18//150// | 20+⁴ | 79//79 | E//E | G//E | G//G |
| A18//200// | 20+⁴ | 72//77 | F//E | G//E | F//G |
| A23//50// | 16.4 | 57//62 | F//G | F//F | F//F |
| A23//100// | 18.2 | 61/64 | G//G | F//G | F//F |
| A23//150// | 15.9 | 59/61 | F//G | F//F | F//F |
| A23//200// | 12.6 | 54/59 | F//G | F//F | F//F |
| A24//50// | 14.6 | 58/61 | G//G | F//F | F//F |
| A24//100// | 16.2 | 60/60 | G//G | F//G | F//F |
| A24//150// | 15.7 | 55/60 | F//G | F//F | F//F |
| A24//200// | 12.9 | 57/57 | F//G | F//F | F//F |
| A28//50// | 18.4 | 57/62 | F//G | F//F | F//F |
| A28//100// | 18.9 | 56/61 | G//G | F//G | F//F |
| A28//150// | 16.1 | 54/60 | F//G | F//F | F//F |
| A28//200// | 12.0 | 57/58 | F//G | F//F | F//F |
| A33//50// | 15.4 | 57/60 | F//G | F//F | F//F |
| A33//100// | 20+⁴ | 59/60 | G//G | F//G | F//F |
| A33//150// | 19.9 | 55/57 | F//G | F//F | F//F |
| A34//200// | 11.6 | 53/56 | F//G | F//F | F//F |
| A34//50// | 17.2 | 57/60 | F//G | F//F | F//F |
| A34//100// | 18.8 | 60/62 | G//G | F//G | F//F |
| A34//150// | 15.6 | 54/60 | F//G | F//F | F//F |
| A34//200// | 11.3 | 52/59 | F//G | F//F | F//F |

Notes:
¹Impressions/hr., EPA Method 24.
2) Face to face-24 hr. @ 50 psig.
³ Tested after immersion for 24 hr. in the specified corrosive, after which the test specimens were each subjected to 10 wipes with a cellulose sponge wetted with test material @ 15 psig. Performance was rated based on percentage of original color density retention (averaged over 10 test specimens): E, =>90%; G, =75-89%; F, =50-69%; and P, =<50%.
⁴Print rate was press, not product performance limited.

### Example 3

This example demonstrates the superior utility of the VOC free vehicles of the instant invention as waterborne epoxy wood coating vehicle components.

A two component waterborne, VOC free acrylic epoxy coating was prepared by sequentially dispersing 10 weight percent each of titanium dioxide, and Muscovite mica in a 31 weight percent aqueous resin solution prepared by the reaction product of) 0.40 milliequivalents of A7 and 100 meq. of B5 resin in water. Varying proportions of Bisphenol A di epoxide, epoxy equivalent weight (EEW) 190, as indicated were added to 100 g aliquots of said resin, the resultant material was thoroughly mixed, and applied to smooth, clean, clear 12″×12″×1″ spruce panels and permitted to dry @ 25°+/−2° C. The resultant coatings were evaluated after 24 and 95 hours of drying. The results are indicated in Table 3. Similarly prepared, applied, cured, and evaluated were a number of analogous (30% resin solids) epoxy coatings. Formulation, drying conditions and test results are tabulated in Table 3.

TABLE 3

| | Carboxyl | Bis A | | | |
|---|---|---|---|---|---|
| Amine., | comp. | epoxy | Dry time¹. | Abrasion | Isopropanol |
| //meq | 100 meq | //meq | hr. | res² | res³ |
| CA//50 | B3 | 200 | 25 | 230 | 24 |
| CA//100 | B8 | 200 | 25 | 410 | 36 |
| CA/100 | B8 | 200 | 95 | 670 | 51 |
| CD//40 | B2 | 180 | 25 | 260 | 40 |
| CD//70 | B7 | 240 | 25 | 315 | 38 |
| CD//70 | B7 | 240 | 95 | 520 | 50 |
| CD//40 | B9 | 180 | 25 | 365 | 27 |
| A15//40 | B2 | 180 | 25 | 2040 | 173 |
| A15//50 | B3 | 200 | 25 | 2635 | 204 |
| A15//70 | B7 | 240 | 25 | 2195 | 201 |
| A15//70 | B7 | 240 | 95 | 3030 | 243 |
| A15//40 | B9 | 180 | 25 | 2780 | 217 |
| D//50 | B3 | 200 | 25 | 1375 | 85 |
| D/70 | B7 | 240 | 25 | 1490 | 61 |
| D/100 | B8 | 200 | 95 | 1325 | 76 |
| D/140 | B9 | 180 | 25 | 1530 | 73 |

Notes
¹ASTM D 1640
²ASTM D 4213
³ASTM D 1308

### Example 4

This example demonstrates the superior utility of the VOC free vehicles of the instant invention as adhesives.

Four mm wet film layers of the indicated products, were each doctor blade applied on smooth horizontal 10×200×3 mm (thick) samples of the stated substrates were prepared by doctor blade application of 20 weight percent dispersions, of the indicated components at the stated molecular mix ratios. the resulting wet films were each dried for ten minutes at ambient conditions (22-30° C., and 70-80% relative humidity), followed sequentially by coverage with a second sample of identical substrate, oven drying for three hours at 100° C. (˜5% relative humidity), cooling at ambient for forty eight hours, and measuring delamination peel strengths in joules per linear cm via ASTM D 4541. The results of these tests are compiled in Table 4.

TABLE 4

| | | | Peel Strength |
|---|---|---|---|
| VOC Free Vehicle | Third Component | Substrate | (JLC)¹ |
| B1//CA-0.5 | Polyvinyl acetate | aluminum | 241 |
| B8//CD-1.5 | Ethylene ethyl acrylate | polyethylene | 182 |
| | | terphthalate | |
| B9//CE-2.0 | none | nylon 6 | 207 |
| B103//D5 | dimmer acid amide² | 316 ss. | 169 |
| B1//A2-0.5 | Polyvinyl acetate | aluminum | 395 |
| B8//A4-1.5 | Ethylene ethyl acrylate | polyethylene | 47 |
| | | terphthalate | |
| B9//A9-2.0 | none | nylon 6 | 509 |
| B10//A21-1.5 | dimmer acid amide² | 316 ss. | 381 |

Notes:
¹ASTM 5179.
²Henkel Corp.

### Example 5

This example demonstrates the superior utility of VOC free vehicles of the instant invention as waterborne gravure printing ink vehicles. Test results clearly indicate that the materials of the instant invention impart enhanced productivity, and yield and sharper images (reduced dot gain) as compared to conventional analogs.

Waterborne gravure inks were prepared by sequentially admixing the stated components in the molar ratios indicated to produce 40% solids containing vehicles. These were diluted 8:1 with the indicated (50% solids) latex resins, followed by the dispersion of 15 weight percent of phthalocyanine blue pigment (15:0) in said blends using a Perl mill. All formulations were reduced to constant color intensity (spectrophotometer) by the addition of appropriate proportions of additional vehicle, then diluted to application viscosity with water. The resultant inks were printed on 60 lb. coated paper stock using a varying coverage (10 to 80%) test pattern cylinder on a commercial (3 meter web at the maximal sustainable (drying rate limited) line speed in meters/min.) (at 80° C. drying temperature) for each sample. Productivity (maximum impressions/hr.), yield (pages/g pigment), and aesthetics (dot gain) were evaluated for each sample. The results are provided in Table 5

TABLE 5

| | Latex | Color | | | dot |
|---|---|---|---|---|---|
| Composition-ratio | Resin | redn. % | productivity | yield | gain % |
| B1//D3-0.5 | B*4 | 14 | 805 | 560 | 26 |
| B5//CC-1.0 | B*2 | 12 | 840 | 590 | 31 |
| B7//D-2.0 | B*1 | 9 | 725 | 545 | 27 |
| B1//A11-0.5 | B*4 | 27 | 920 | 720 | 12 |
| B5//A8-1.0 | B*2 | 22 | 880 | 690 | 15 |
| B7//A4-2.0 | B*1 | 38 | 1030 | 735 | 9 |

### Example 6

This example demonstrates the utility of the VOC free vehicles of the instant invention as VOC free coalescents for latex acrylic and polyvinyl acetate latex resin architectural paints.

White latex architectural paints were prepared by high speed mixer dispersion of 200 g of titanium dioxide in 300 g of each of the indicated grind vehicles to a Hegman grind of 7+, followed by let down with the 400 g of the stated latex resin, and 100 g. of water. Viscosity was adjusted to 80+/− Krebs units, with (Polyphobe 102-Union Carbide), and the resulting pains applied via doctor blade, at 3 mils wet thickness to standard draw-down cards (Lenneta #9A), and dried for four hours at ambient temperature. Opacity and gloss were each measured via ASTM methods D2805 and D523 respectively. The resulting data are provided in Table 6. The grid vehicles employed in each of the preceding was comprised (in parts by weight) of Polyphobe 102 3, potassium di phosphate 2, defoamer (Defo X123-Ultra Additives) 2, biocide (Nuosept 95-Crenova) 2, additive as shown, and water-balance.

TABLE 6

| | | Paint | Paint gloss @ |
|---|---|---|---|
| Grind vehicle additive(s)\PBW¹ | Resin | opacity % | 60′ % |
| Butyl cellosolve\50 | PVAc² | 72 | 47 |
| B6//CA*2-1.0\5 | ″ | 64 | 29 |
| B7//CD-2.0\5 | ″ | 67 | 8³ |
| B6//A9-1.0\5 | ″ | 76 | 56 |
| B7//CD-2.0\5 | ″ | 67 | 63 |
| Butyl cellosolve\50 | Acrylic⁴ | 72 | 47 |
| B6//CA*2-1.0\3 | ″ | 64 | 11³ |
| B7//CD-2.0\3 | ″ | 67 | 12³ |
| B6//A9-1.0\3 | ″ | 76 | 84 |
| B7//CD-2.0\3 | ″ | 67 | 88 |

Notes:
¹Parts By Weight,
²Flexbond 381(Air Products),
³Coalescence incomplete-film non-uniform,
⁴SG-10M (Rohm and Haas)

### Example 7

This example demonstrates the utility of the VOC free vehicles of the instant invention as VOC free coalescents in direct to metal anticorrosive coatings.

White latex metal protective waterborne baking enamels were prepared by high speed mixer dispersion of 200 g of titanium dioxide in 300 g of each of the indicated grind vehicle to a Hegman grind of 7+, followed by let down with 300 g of SC Johnson 538 acrylic resin, 50 g of melamine resin (Cymel 303-Cytec), and 100 g. of water. Viscosity was adjusted to 80+/−5 Krebs units, with (Polyphobe 117-Union Carbide), and the resulting paints applied via doctor blade, at 3 mils wet thickness to standard carbon steel test panels (QUV)), oven baked at 160° C. for 20 minutes, and cooled for 48 hours at ambient temperature. Opacity, salt spray resistance, and gloss were each measured via ASTM methods D 2805-88, B 117, and D 523, respectively. The resulting data are provided in Table 6. The grind vehicle employed in each of the preceding was comprised (in parts by weight) of acrylic latex (#540 SC Johnson)-200 Polyphobe 117 3, potassium di phosphate 2, defoamer (Defo X123-Ultra Additives) 2, biocide (Nuosept 95-Crenova) 2, additive as shown, and water-balance.

TABLE 7

| Grind vehicle | Paint | Paint gloss % | Salt spray |
|---|---|---|---|
| additive(s)\PBW¹ | opacity % | @ 60° | resistance hr. |
| Butyl cellosolve\65 | 72 | 77 | 304 |
| B1//CA*4-1.0\10 | 64 | 6² | 84 |
| B8//CE-2.0\10 | 67 | 8² | 72 |
| B1//A9-1.0\10 | 76 | 56 | 610 |
| B8//A9-2.0\10 | 67 | 63 | 560 |
| B6//A*12-2-1.0\10 | 64 | 31² | 125 |
| B6//A19-2.0\10 | 67 | 52 | 460 |
| B7//A9-0.5\10 | 76 | 84 | 700 |
| B7//A9-2.0\10 | 67 | 88 | 560 |

Notes:
¹Parts by weight.
²Film coalescence incomplete.

### Example 8

This example demonstrates the utility of the VOC free vehicles of the instant invention, as VOC free, performance improvers for alkyds.

Solvent (29.7% of 30% w/w nominal) was removed from Setal-41-1390 resin via distillation in vacuum to produce a viscous product bp₈>160° C. This essentially solvent free product was used for all subsequent evaluations. One thousand gram portions of 40 weight % solids aqueous solutions/dispersions of concentrated Setal 41-1390 were prepared by dissolving the resin in aqueous mixtures containing an equimolar proportion of the indicated amine. Five grams of antifoam (Defo 3020-Ultra Additives were added to each, followed by the introduction and high sheer dispersion of 50 g of carbon black pigment (R400R-Cabot), and 1.5 g each of 12% cobalt and manganese naphthenates. The resulting materials were each independently doctor blade coated on aluminum test panels (QUV). The coated panels were permitted to air dry at ambient temperature for seven days, after which they were evaluated for adhesion via ASTM D-4521, and abrasion resistance via ASTM D-4060, respectively. Results are tabulated in Table 8.

TABLE 8

| | | Tabor abrasion cycles/mil |
|---|---|---|
| Amine employed | Peel Strength (JLC) | (1000 g load) × 10 |
| CA | 163 | 74 |
| CD | 142 | 81 |
| CA*3 | 127 | 77 |
| A1 | 191 | 123 |
| A6 | 264 | 142 |
| A11 | 257 | 150 |
| A12* | 171 | 99 |

### Example 9

This example demonstrates the utility of the VOC free vehicles of the instant invention as VOC free coalescents for latex acrylic, chlorinated rubber, and polyvinyl acetate latex resin based floor coatings.

Floor Wax concentrates containing 2 weight percent of the indicated amine-carboxylated resin adducts were prepared in situ by the addition of the appropriate reagents in the defined molar ratios, and 0.25 weight percent each of surfactant blend, and antifoam to latex resins defined in Table 9. The resultant concentrates were each reduced to 20% solids content by dilution with water, followed by four coats of mop application, with intermediate air drying to freshly cleaned semi-rigid vinyl floor tiles. The resulting coatings were evaluated for aesthetics, and durability (foot traffic) and compared to comparable coatings produced from commercially available VOC laden floor waxes. Results are given in Table 9.

TABLE 9

| Amine// | | | | | |
|---|---|---|---|---|---|
| Carboxylate- | Latex | | Wear | Solvent | |
| M//M | resin | Streaks | resistance | resistance | Odor¹ |
| CA//B5-1.0 | PVA² | severe | poor | poor | moderate |
| CE//B5-1.0 | ″ | ″ | ″ | ″ | low |
| CA*5//B5-1.0 | ″ | ″ | ″ | ″ | minimal |
| A2//B5-1.0 | PVA² | modest | fair | fair | minimal |
| A6//B5-1.0 | ″ | ″ | ″ | ″ | low |
| A*5//B5-1.0 | ″ | ″ | ″ | ″ | minimal |
| CA//B5-1.0 | Acrylic³ | severe | good | fair | moderate |
| A2//B5-1.0 | ″ | minimal | fair | good | minimal |
| A6//B5-1.0 | ″ | modest | good | good | low |
| A*5//B5-1.0 | ″ | ″ | ″ | ″ | minimal |

Notes:
¹During application.
²UCAR 379G (Union Carbide).
³UCAR 626 (Union Carbide).

All references cited herein, whether in print, electronic, computer readable storage media or other form, are expressly incorporated by reference in their entirety, including but not limited to, abstracts, articles, journals, publications, texts, treatises, internet web sites, databases, standards and methods/protocols of standardization and/or regulatory agencies, patents, and patent publications.

While we have described a number of embodiments of this invention, it is apparent that our basic examples may be altered to provide other embodiments that utilize the products and processes of this invention. Therefore, it will be appreciated that the scope of this invention is to be defined by the claims rather than by the specific embodiments that have been represented by way of example.

1. A composition of matter comprising one or more polymeric organic carboxylic acid group containing resin(s) and one or more multifunctional hydroxyl bearing di/oligoamines.

2. A composition of matter comprising a volatile organic compound (“VOC”) free waterborne vehicle, which comprises one or more polymeric organic carboxylic acid group containing resin(s), and one or more multifunctional hydroxyl bearing di/oligoamines.

3. The composition of claim 1 or 2 wherein the multifunctional hydroxyl bearing di/oligoamine(s) are essentially nonvolatile.

4. The composition of claim 1 or 2 wherein the multifunctional hydroxyl bearing di/oligoamine(s) comprise at least one primary amino ligand(s).

5. The composition of claim 1 or 2 wherein the multifunctional hydroxyl bearing di/oligoamine(s) comprise at least one primary amino ligand(s) and at least one hydroxyl group.

6. The composition of claim 1 or 2 wherein the polymeric organic carboxylic acid group containing resin(s) further comprises non-carboxylic acid based monomers.

7. The composition of claim 1 or 2 wherein the polymeric organic carboxylic acid group containing resin(s) comprises at least one free carboxylic acid groups.

8. A composition of claim 1 or 2 comprising one or more polymeric organic carboxylic acid group functional equivalent(s).

9. A composition of matter comprising a volatile organic compound (“VOC”) free waterborne vehicle, comprising one or more polymeric organic carboxylic acid group containing resin(s), which polymers may further comprise non-carboxylic acid based monomers, and essentially nonvolatile multifunctional hydroxyl bearing di/oligoamines.

10. A composition of claim 1 or 2 further comprising an additional solvent.

11. The composition of claim 10 comprising water as an additional solvent.

12. The composition of claim 10 comprising an organic solvent as an additional solvent.

13. A use of a composition of claim 1 or 2 as an epoxy curative.

14. A use of a composition of claim 1 or 2 as a vehicle for a coating.

15. A use of a composition of claim 1 or 2 as a vehicle for a paint.

16. A use of a composition of claim 1 or 2 as a vehicle for a print ink.

17. A method of producing an epoxy curative, coating, paint, or print ink, comprising combining the components of the composition of claim 1.

18. A method of producing an epoxy curative comprising combining the components of the composition of claim 1 and one or more additional epoxy curative additive or additives.

19. A method of producing a coating comprising combining the components of claim 1 and one or more additional coating additive or additives.

20. A method of producing a paint comprising combining the components of claim 1 and one or more additional paint additive or additives.

21. A method of producing a print ink comprising combining the components of the composition of claim 1 or 2 and one or more additional print ink additive or additives.

22. A method of making a composition of claim 1 or 2 comprising combining one or more polymeric organic carboxylic acid group containing resin(s) and one or more multifunctional hydroxyl bearing di/oligoamines.

23. A product made by the process of any of claims 17-22.

24. A method of printing on a substrate comprising applying a product prepared by the method of claim 21 or 22 to the substrate.

25. A method of painting a substrate comprising applying a product prepared by the method of claim 20 or 22 to the substrate.

26. A method of coating a substrate comprising applying a product prepared by the method of claim 19 or 22 to the substrate.

27. A method of curing an epoxy on a substrate comprising applying a product prepared by the method of claim 18 or 22 to the substrate.

28. A method of adhering a first substrate to a second substrate comprising applying a product prepared by the method of claim 17 or 22 to the first substrate and contacting the first substrate to the second substrate.

29. The method of claim 28, further comprising applying a product prepared by the method of claim 17 or 22 to the second substrate.

30. A method of protecting a substrate surface comprising applying a product prepared by the method of claim 17 or 22 to the substrate surface.

31. A composition of matter comprising one or more polymeric organic carboxylic acid group containing resin(s) and one or more multifunctional hydroxyl bearing di/oligoamines, as defined in formula A.
H[RNHR¹]ₓ[R²N(R³)R⁴]_{y}[R⁵(OH)R⁶]_{z}H Formula A
wherein each R, R¹, R², R⁴ and R⁶ is independently a bond, divalent hydrocarbyl, or oxa hydrocarbyl ligands, each such ligand having from one to about six carbon atoms, inclusive of optional ether substituents (e.g., [—OCH₃ or —OC₃H₇]. Each R³, is independently hydrogen or monovalent one to six carbon saturated, or 2 to 6 carbon containing unsaturated hydrocarbyl or oxa hydrocarbyl ligand, and each R⁵, is independently chosen from among one to four carbon containing trifunctional ligands, wherein (x) and (y) are each independently an integer having a value of 0 to 6, except that the sum of x+y must equal or exceed 2, (z) is an integer having a value of 1, 2, or 3.
